(19) United States
(12) Patent Application Publication
(10) Pub. No.: US 2018/0285969 A1
(43) Pub. Date: Oct. 4, 2018

(54) PREDICTIVE MODEL TRAINING AND SELECTION FOR CONSUMER EVALUATION

(71) Applicant: Experian Health, Inc., Franklin, TN (US)

(72) Inventors: Christopher G. Busch, Maple Grove, MN (US); Sean M. Porter, Plymouth, MN (US); Nathaniel W. Lutz, Eagan, MN (US)

(73) Assignee: Experian Health, Inc., Franklin, TN (US)

(21) Appl. No.: 15/474,935

(22) Filed: Mar. 30, 2017

(51) Int. Cl. G06Q 40/02; G06N 5/04; G06F 17/30; G06N 99/00

(52) U.S. Cl. CPC G06Q 40/025; G06N 99/005; G06F 17/30312; G06N 5/04

(57) ABSTRACT

Predictive model development, training, evaluation, and selection are provided for enabling more-accurate evaluations of consumers. Aspects of an evaluation system use machine learning techniques to train models based on training datasets and known outputs provided by one or more service providers (e.g., pieces of demographic data and historical transaction data). The predictive models are developed against the training datasets to optimize the predictive models to correctly predict an output (e.g., a consumer propensity) for the given inputs. When a consumer seeks services from a service provider, the service provider provides pieces of demographic data and ongoing transactions data to the evaluation system. A most-accurate predictive model is selected based on known data elements, and a propensity score is calculated indicative of a likelihood of settlement by the consumer. Results are communicated with the service provider such that informed decisions can be made.

### BACKGROUND

Service providers oftentimes provide services for a vast number of diverse consumers with different backgrounds and transactional situations. When an individual seeks services from a service provider, the computer systems of the service provider (or the provider's agent(s)) perform various processes to provide services to consumers and to charge for those services. For example, the various processes may be part of a service access workflow system, such as a patient access workflow system used by healthcare providers to process patients, a client access workflow system used by attorneys to process clients, or a student access workflow system used by educational institutions to process students.

One example process is a clearance process for determining the individual's (or another party responsible for the individual) ability or propensity to meet obligations, or for determining the individual's eligibility for various pre-arrange assistance programs. Typically, a primary source of information for determining the individual's ability is a historical transaction state (e.g., credit score), household income, and household size data obtained from a credit reporting agency (CRA). However, there are many individuals for whom a CRA may not have information available. Additionally or alternatively, some service providers are not provided enough information from an individual to match to a CRA for obtaining information for determining the individual's ability.

### SUMMARY

The present disclosure provides systems, methods, and a computer readable storage medium for improving the functionality of service access workflow systems. A reduction in the amount of processing resources needed to predict a payment probability for a consumer is provided, which improves the efficiency of a service access workflow system. Although examples are presented primarily regarding the healthcare industry, these are presented as non-limiting examples, as service providers in other service industries (e.g., automotive, educational, travel) may also make use of aspects of the present disclosure.

Aspects of an evaluation system provide for developing and training a plurality of predictive models using one or more machine learning techniques based on training datasets and known outputs. Aspects of the evaluation system use machine learning techniques to train predictive models to accurately make predictions on a likelihood of a consumer meeting obligations for services provided by the service provider. During a learning phase, the predictive models are developed against a training dataset of known inputs (e.g., pieces of demographic data and historical transaction data) to optimize the predictive models to correctly predict an output (e.g., settlement likelihood) for a given input. Aspects of the evaluation system systematically omit certain input data elements that are available to help train the predictive models to predict the output without the input(s). The predictive models are evaluated and scored on accuracy of handling data that the models have not been trained on.

When a consumer seeks services from a service provider, the service provider may want to determine settlement propensity of the consumer. Accordingly, the service provider provides input data including pieces of demographic data and historical transaction data to the evaluation system. Aspects of the evaluation system identify and select a predictive model having the highest accuracy score for determining settlement likelihood based on the known data elements available in the received input data. In some examples, a predictive model may have a higher accuracy score, but requires one or more data elements that are missing from the received input data. In such cases, one or more data sources are searched for the missing data elements. After selection of a most-accurate predictive model based on the information available, aspects of the evaluation system populate fields of the selected predictive model with the available data elements for generating a propensity score indicative of a likelihood of settlement by the consumer. In some examples, known information about a consumer are compared against certain thresholds to determine eligibility for voluntary assistance programs or other transactional assistance programs. Results are communicated with the service provider such that the service provider is enabled to make informed decisions with respect to the consumer.

Aspects of systems and methods described herein may be practiced in hardware implementations, software implementations, and in combined hardware/software implementation. This summary is provided to introduce a selection of concepts; it is not intended to identify all features or limit the scope of the claimed subject matter.

### BRIEF DESCRIPTION OF THE DRAWINGS

The accompanying drawings, which are incorporated in and constitute a part of this disclosure, illustrate various aspects and examples of the present invention. In the drawings:

FIG. 1 is a block diagram illustrating an example evaluation system operative to provide predictive model training and selection;

FIG. 2 illustrates components for providing predictive model development, training, and diagnostic evaluation;

FIG. 3 illustrates an example user interface as may be seen by a user when viewing results of the evaluation system;

FIG. 4A is a flow chart showing general stages involved in an example method for generating and training a plurality of predictive models;

FIG. 4B is a flow chart showing general stages involved in an example method for selecting a predictive model based on available data and calculating a propensity score for a consumer;

FIG. 5 is a block diagram illustrating physical components of an example computing device with which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

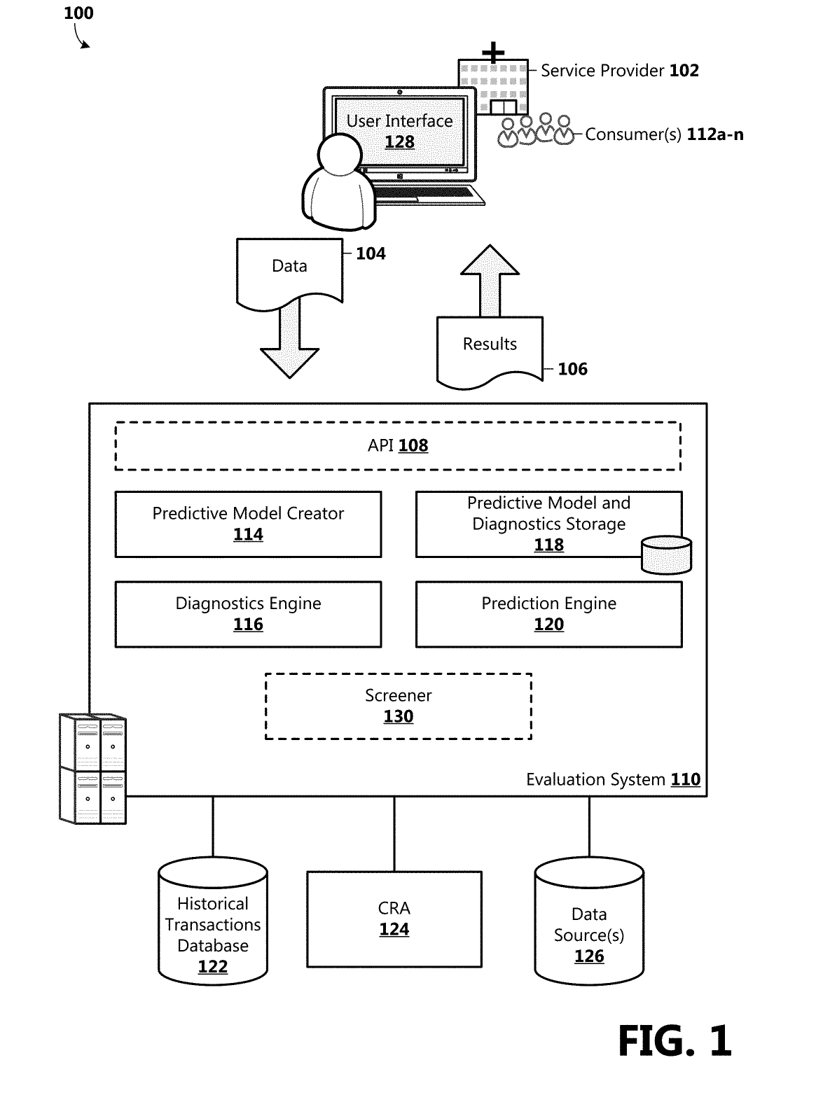

The present disclosure provides systems and methods for improving evaluation of a consumer. The present disclosure provides development, training, and evaluation of predictive models to accurately make predictions regarding a consumer based on known or available data associated with the consumer. FIG. 1 is a block diagram illustrating an example operating environment 100 including an evaluation system 110 operative to provide propensity predictions. According to examples, the evaluation system 110 or components of the system are part of a service access workflow system, such as a patient access workflow system used by healthcare providers to process patients, a client access workflow system used by attorneys to process clients, or a student access workflow system used by educational institutions to process (prospective) students. Although examples are given herein primarily using a patient access workflow system and involving healthcare providers and patients, it will be recognized that the present disclosure is applicable to several fields where persons seeking services are faced with high service costs, and the service providers are faced with the difficulty of deciding whether to deny service, provide service at risk to themselves (or later seek to collect the outstanding obligations themselves), and to reach that conclusion in a time sensitive environment. Improvements to the accuracy, speed, and capabilities of these service access workflow systems not only improve the systems themselves, but reduce the risks to providers in providing services and improve patient access to healthcare, client access to legal services, student access to educational services, etc. As used herein, “accuracy” and its related adjectives and adverbs do not refer to the correctness of how calculations are preformed (which are assumed to be performed correctly, unless stated otherwise), but refer to how close an estimate is to a final value.

In some examples, one or more components of the evaluation system 110 are part of an integrated consumer processing system, which may be provided as a singular service that multiple service providers 102 can access. In various aspects, a service provider 102 is enabled to access the evaluation system 110 remotely via a thin client, which receives data 104 from the service provider and posts back results 106 in a user interface 128 via a web browser or a dedicated application running on a terminal or server operated by the service provider used to communicate with the evaluation system 110. In some examples, an application programming interface 108 (API) is provided for enabling a third-party application to employ propensity prediction via stored instructions. In some examples, one or more components of the evaluation system 110 are maintained and operated by an intermediary service provider that acts as an interface between service providers 102 and information sources (e.g., data sources 126).

According to an aspect, the evaluation system 110 comprises a model creator 114 that is configured to use input data 104 provided by one or more service providers 102 to generate and train a plurality of predictive models for determining propensities of a consumer 112 based on various sets of input data. For example, the input data 104 includes ongoing transactions data that provides information about amounts due from a consumer 112 and amounts settled by the consumer. Additional ongoing transaction data elements may be included, such as a number of visits made in a time period by a consumer 112, types of visits (e.g., outpatient vs emergency), pre-arranged assistance status (e.g., insurance), a length of history, a number of ongoing transactions that have been transferred to recovery agents, etc. According to an aspect, the evaluation system 110 includes a historical transactions database 122 for storing a history of consumers 112. Further, the input data 104 may include one or more pieces of demographic data, such as the consumer's name, street address, city, state, ZIP code, an indication of whether the address is a single family dwelling or a multiple family dwelling, consumer identifier, social security number (SSN), date of birth (DOB), etc. In some examples, various pieces of demographic data may be verified or retrieved from a CRA 124 or other data source 126. According to an aspect, the evaluation system 110 may be provided as a service that can be accessed by multiple service providers 102. Accordingly, in some examples, prior to training predictive models, the predictive model creator 114 is operative to depersonalize or sanitize the input data 104 (e.g., remove consumer names, SSNs, other consumer-identification information).

The predictive model creator 114 is configured to generate and train set of predictive models via one or more machine learning techniques using a training set of data related to consumers 112. Machine learning techniques train models over several rounds of analysis to make predictions based various input data. According to an aspect, the predictive models are used accurately make predictions on the propensities of a consumer 112 for meeting obligations for services provided by the service provider 102. During a training phase, the predictive models are developed against a training dataset of known inputs, such as pieces of demographic data and historical transaction data from the service provider 102, to gradually train the predictive models to predict the a propensity for a given set of inputs. In various aspects, the learning phase may be categorized with decreasing levels of which the “correct” outputs are provided in correspondence to the training inputs as: supervised, semi-supervised, or unsupervised. For example, in a supervised learning phase, all of the outputs (e.g., transactional histories regarding settlement amounts) are provided to the predictive model creator 114 to develop a predictive model embodying a general rule to reflect the input (e.g., various pieces of demographic data, various pieces of transactional data) to the output (e.g., a settlement amount). According to an aspect, the predictive model creator 114 systematically omits certain input data elements that are present to help train the predictive models to predict the output with certain input values missing.

The predictive models are run for several rounds, also referred to as epochs, against the training dataset so that the outputs from the predictive models may more accurately predict propensities for a given set of inputs. Consider, for example, a predictive model that is created for a given set of inputs: X, Y, and Z, to produce an output A. The example predicative model is evaluated over several rounds with various values of X, Y, and Z and is judged against known outputs A in the training set so that the predictive model may be modified between rounds to more reliably provide the output A that is specified as corresponding to the given input set X, Y, Z for the greatest number of input sets in the training dataset.

The predictive models are refined at the end of each round based on evaluations of the outputs relative to the inputs so that the predictive model creator 114 can adjust the values of the variables within the model to fine-tune the predictive model to more accurately match the inputs to the known outputs between rounds. The predictive model creator 114, depending on the machine learning technique used, adjusts the internal variables of the predictive models in various ways. Several machine learning techniques that may be applied with the present disclosure, including linear regression, random forests, decision tree learning, neural networks, etc., will be familiar to one of ordinary skill in the art, are will not be discussed so as not to distract from the present disclosure.

Because the training dataset may be varied, and is preferably very large, perfect accuracy and precision may not be achievable across an entire training dataset for mapping a rule for inputs to a prediction to outputs. The predictive model creator 114 therefore develops the models over several rounds to map to a desired output result to the given inputs as closely as possible for as many inputs as possible given a desired number of rounds or a fixed time/computing budget in which to produce the models. In other aspects, the training rounds are ended early when the accuracy of a given predictive model satisfies an accuracy threshold (high or low) or accuracy between rounds is seen to vacillate or plateau. For example, if an accuracy threshold of 90% is set, a training phase that is designed to run n rounds may end before the nth round and use whenever a predictive model with at least 90% accuracy is produced. In another example, if a low accuracy threshold (e.g., a random chance threshold) states that training should be terminated for any model only 60% accurate, a training phase that is designed to run n rounds may end before the nth round for a given predictive model with an accuracy of less than 60% (although other models may continue training). In a further example, the training phase for the given model may terminate early when a given predictive model bounces between accuracy levels between rounds, e.g., 91% accurate, 90% accurate, 91% accurate, 90% accurate, etc.

After completion of training for a given model set, the predictive model creator 114 finalizes the predictive models, for evaluation against testing criteria by the diagnostic engine 116. In a first example, a testing dataset that includes known outputs (e.g., settlement history) for its inputs (e.g., pieces of demographic data and historical transaction data) is provided into the finalized predictive models to determine diagnostics data, such as an accuracy score of the predictive model in handling data that the model was not trained on. In another example, a false positive rate, false negative rate may be used to evaluate the predictive models after finalization. The predictive models and diagnostics data are stored in a predictive model and diagnostics storage 118.

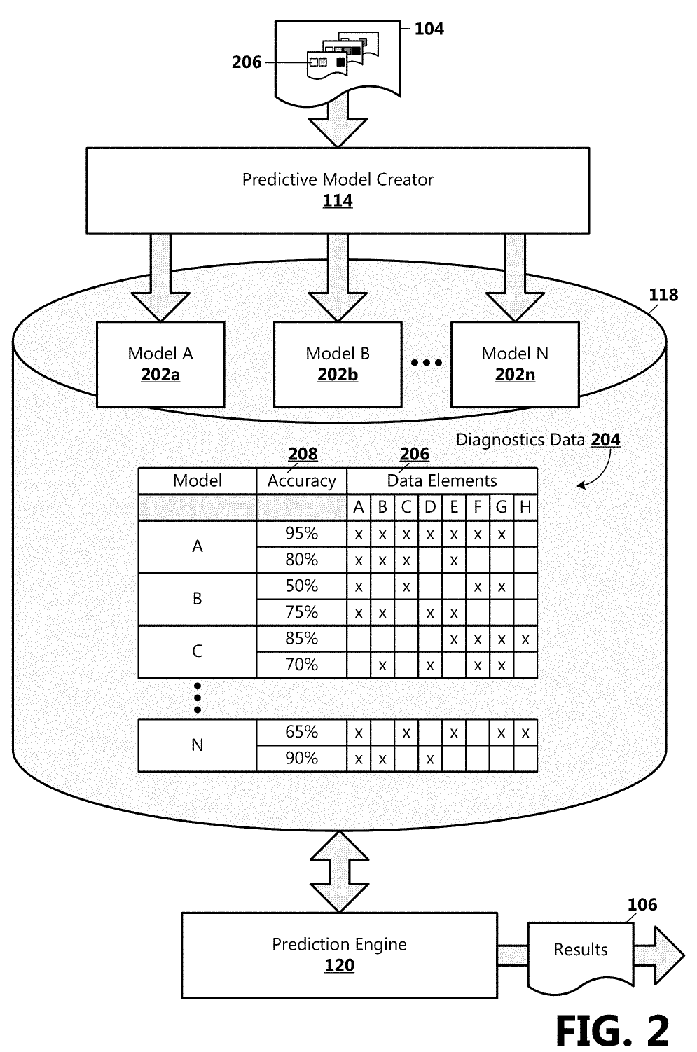

FIG. 2 illustrates the model creation/learning and evaluation phases performed by the predictive model creator 114 and diagnostics engine 116. As illustrated, the input data 104 are received by the predictive model creator 114 that can comprise varying pieces of data elements 206a-n, such as demographic data elements and ongoing transactions data elements. As data are collected, including data associated with settlement history or amounts obliged/recovered from consumers 112, the predictive model creator 114 is enabled to develop and train a plurality of predictive models 202a-n based on the available data and known outputs. Each predictive model 202 may be developed using different data elements 206.

In one example, one predictive model 202 may be trained by developing a rule or algorithm mapping a known transaction output to data elements 206: a consumer's full name, the consumer's street address, city, state, and ZIP code, and historical transaction data (e.g., a report or score) matching those data elements. In another example, another predictive model 202 may be trained by developing a rule or algorithm mapping a known transaction output to data elements 206: a consumer's full name, the consumer's street address, city, state, and ZIP code. In another example, another predictive model 202 may be trained by developing a rule or algorithm mapping a known transaction output to data elements 206: a consumer-specific identifier and a transaction balance history of the consumer with the service provider 102. In another example, another predictive model 202 may be trained by developing a rule or algorithm mapping a known transaction output to data elements 206: ZIP code and a history of propensity scores provided to the service provider. Other example data elements 206 include a SSN, DOB, a full 9-digit ZIP code, accuracy of an address field including an indication of whether the address is a single family dwelling or a multiple family dwelling, and various ongoing transaction data elements, such as but not limited to: a number of visits to the service provider 102 within a given time period, types of visits or services, pre-arranged assistance status, length of history, and a number of records that have gone into recovery. In training the predictive models 202, the predictive model creator 114 may omit certain known data element fields in a model to help develop a rule without the fields.

In the evaluation phase, the diagnostics engine 116 evaluates the predictive models 202 against testing criteria, and generates diagnostics data 204 including an accuracy score 208 for rating how accurately the models handle data on which they have not been trained. For example and as illustrated in FIG. 2, a first model, Model A 202a, may have an accuracy score 208 of 95% when data elements 206 A, B, C, D, E, F, and G are available or known, and an accuracy score of 80% when data elements A, B, C, and E are available or known. A second model, Model B 202b may have an accuracy score 208 of 50% when data elements 206 A, C, F, and G are available or known, and an accuracy score of 75% when data elements A, B, D, and E are available or known. A third model, Model C 202c, may have an accuracy score 208 of 85% when data elements 206 E, F, and G are available or known, and an accuracy score of 70% when data elements B, D, F, and G are available or known. The diagnostic data 204 can be used to identify which model 202 is a best fit according to available data elements 206 included in received input data for determining propensities for a consumer 112.

With reference again to FIG. 1, when a consumer 112 seeks services from a service provider 102, the service provider 102 may want to determine the consumer's propensities. For example, the service provider 102 may user propensity information in order to assess whether offering a settlement plan to the consumer may help to recover obligations owed or whether a person qualifies for pro bono services or a voluntary assistance program. When a service provider 102 wants to determine propensities of a consumer 112, the service provider provides input data 104 to the evaluation system 110, which can include various pieces of ongoing transactions data and/or demographics data associated with the consumer 112. The received input data 104 may include information for a single consumer 112 or batched information for a plurality of consumers 112a-n. According to an aspect, the evaluation system 110 comprises a prediction engine 120, which is operative to generate a propensity score indicative of a likelihood of a consumer's propensity. In some examples, the prediction engine 120 initially attempts to generate a propensity score based on historical transactions data provided by one or more CRAs 124. For example, if the consumer 112 has an established transaction history and if the service provider 102 provides enough information to obtain a transactional history report for the consumer from a CRA 124, the prediction engine 120 is operative to calculate a propensity score based on the historical transaction report.

Additionally or alternatively, in some examples, the prediction engine 120 is configured to generate a propensity score based on historical transaction records (stored in the historical transactions database 122) associated with the consumer 112. For example, a consumer 112 may not have an established history with a CRA 124, a service provider 102 may not provide enough information to obtain historical transaction reports for the consumer from a CRA 124, or a determination may be made to calculate a propensity score based on historical transaction records (e.g., the consumer's past settlements for services rendered by the service provider 102 or other service providers) instead of or in addition to historical transaction reports.

Additionally or alternatively, the prediction engine 120 is operative to select a predictive model from the plurality of predictive models generated and trained by a predictive model creator 114 for generating a propensity score based on available data. For example, the prediction engine 120 identifies and selects a predictive model that satisfies an accuracy threshold (e.g., a model having the highest accuracy score) for determining propensities based on the data elements available in the received input data 104. In some examples, the prediction engine 120 is operative to identify a predictive model that has a higher accuracy score, but that requires one or more data elements that are missing from the received input data 104. In such cases, the prediction engine 120 is further operative to communicate with one or more data sources 126 for requesting and receiving additional data elements. After selection a most-accurate predictive model based on the information available, the prediction engine 120 is configured to populate fields of the selected predictive model with the available data elements for generating a propensity score for the consumer.

Consider, for example and with reference again to FIG. 2, that data elements 206 A, B, C, E, and G associated with a consumer 112 are known. The prediction engine 120 may identify Model A 202a as a best model to use, wherein data elements A, B, C, and E are satisfied and can produce an outcome with an accuracy score of 80%. According to an aspect, the prediction engine 120 is operative to identify that if data elements D, F, and G were known, the accuracy would be increased to 95%. Accordingly, the prediction engine 120 is configured to communicate with one or more data sources 126 to attempt to retrieve the missing data elements. The one or more data sources 126 may include the service provider information system, a CRA 124, a pre-arranged service provider system, or other information source. If the missing data elements 206 can be retrieved, the prediction engine 120 includes the retrieved data in the data set; else, the prediction engine 120 runs Model A 202a with the known data elements 206, and determines a propensity score for the consumer 112. In some examples, the prediction engine 120 is further operative to associate the propensity score with a recommendation to the service provider 102 regarding steps to take with the consumer 112 to help the service provider 102 to recover from the consumer. The results 106 are then communicated with the service provider 102.

In some examples, the evaluation system 110 includes or is communicatively attached to a screener 130 (illustrated in FIG. 1) that is operative to compare known information about a consumer 112 against certain thresholds to determine eligibility for voluntary assistance programs or other programs offered by the government, private groups, or the service provider 102 itself for the benefit of the public. Results 106 are communicated to the service provider 102. For example, the evaluation system 110 may post back results 106 in a user interface 128 via a web browser or a dedicated application running on a terminal or server operated by the service provider 102.

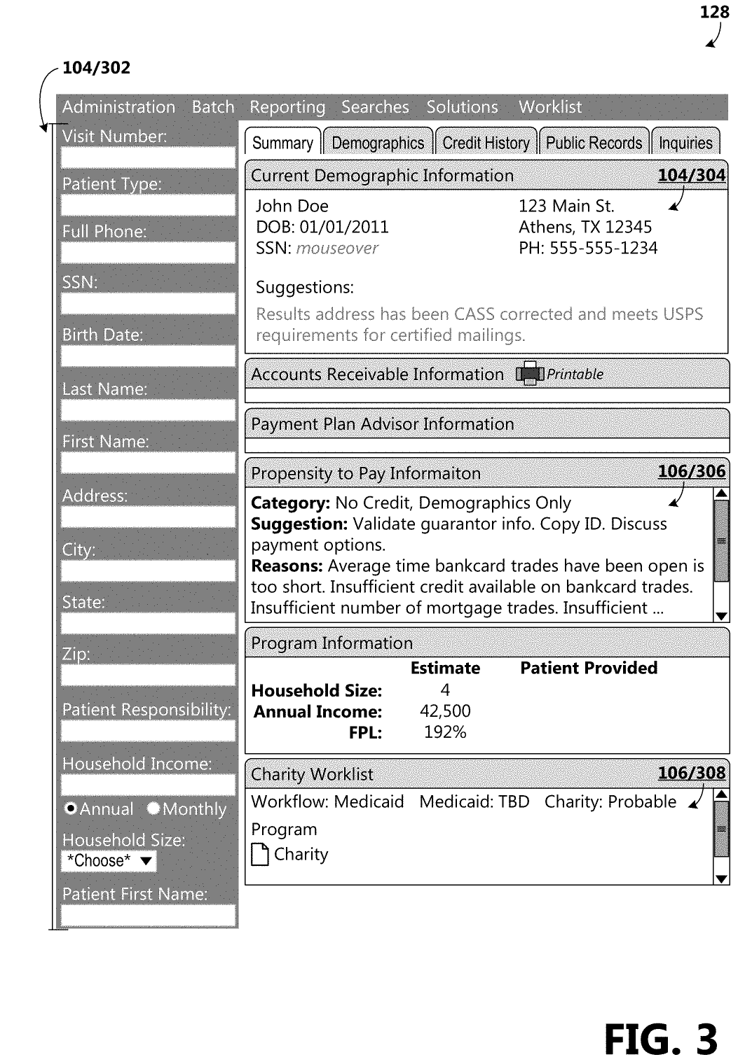

With reference now to FIG. 3, an example user interface 128 as may be seen by a service provider administrative user when viewing results 106 of the evaluation system 110 is illustrated. The example illustrated user interface 128 is an example of a user interface that may be part of a patient processing system. As should be appreciated, aspects of the evaluation system 110 can be used in a variety of service provision fields. As shown on the left side of the illustration, the user interface 128 can include a plurality of input fields 302 which can be populated by various pieces of input data 104. The data that are input or populated into the fields 302 may be dependent on the information provided to the service provider 102 by the consumer 112. Example input fields 302 can include fields for entering demographic information 304 associated with the consumer 112, such as the consumer's name, address, phone number, DOB, SSN, visit number, household size, etc. In some examples, an input field 302 is provided for entering or populating a consumer responsibility amount. When the information has been entered into the input fields 302, the input data 104 are communicated to the evaluation system 110 for determining the consumer's propensity to settle obligations for services.

As shown on the right side of the illustration, results 106 from the prediction engine 120 are provided to the service provider 102 and are displayed in the user interface 128. The results 106 include propensity information 306 determined by the prediction engine 120. For example, the propensity information 306 can include information associated with how the consumer's propensity was determined (e.g., based on historical transaction report information, the consumer's historical transaction records with the particular service provider 102 or another service provider, demographic information), a suggestion regarding steps to take with the consumer 112 to help the service provider to recover from the consumer, and reasons for the suggestion. In some examples, the propensity score calculated by the prediction engine 120 is also included in the results 106. Further, voluntary assistance program results 308 can be included and displayed in the user interface 128. For example, the voluntary assistance program results 308 can include an indication as to whether the consumer 112 qualifies for discounted services and the information used to make the determination. As should be appreciated, the illustrated example is a non-limiting example. Other information can be input into the user interface 128 and provided in the results 106 and displayed in the user interface 128.

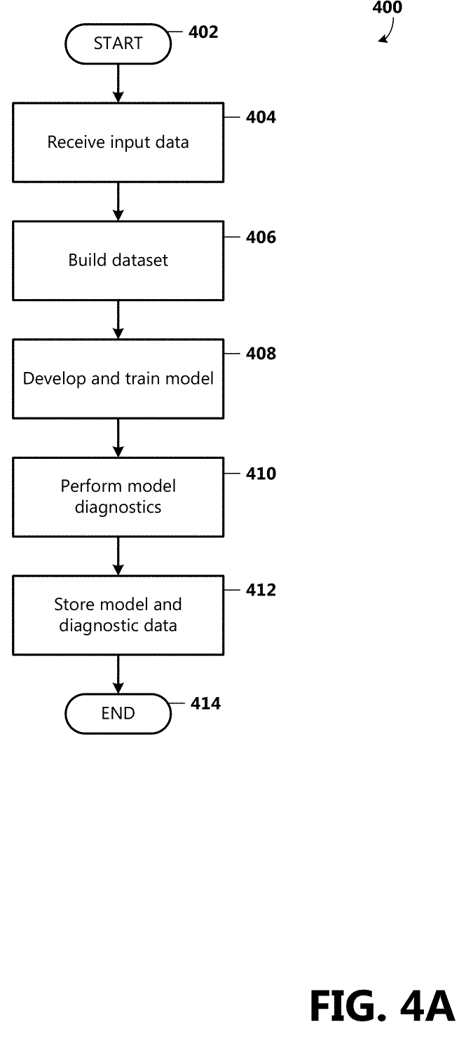

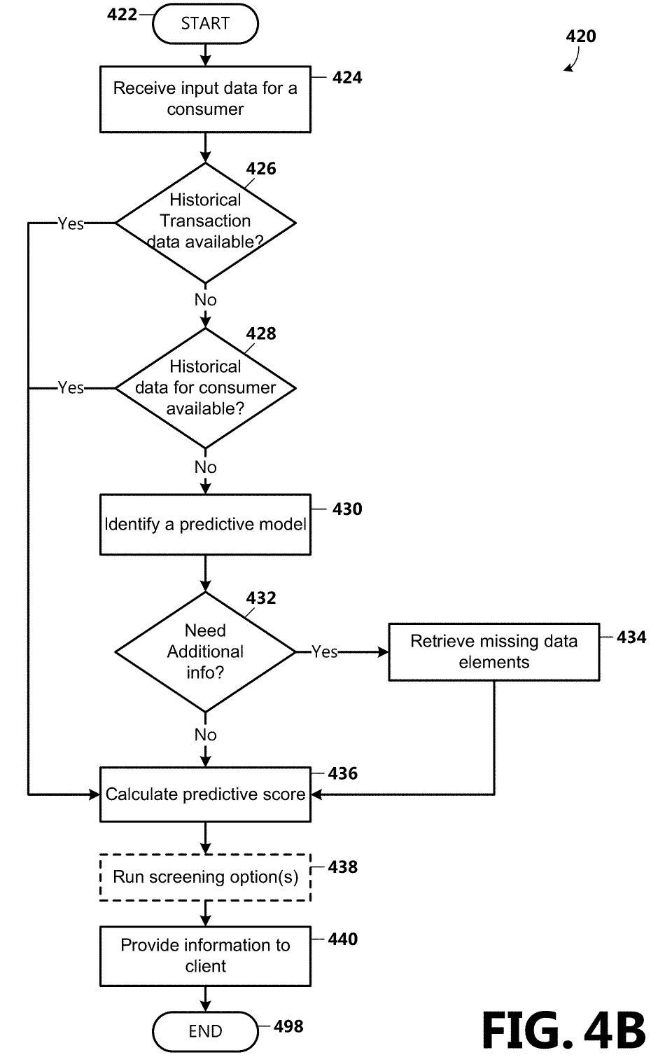

FIG. 4A is a flow chart showing general stages involved in an example method 400 for generating and training a plurality of predictive models 202a-n for determining a consumer's propensities. The method 400 starts at START OPERATION 402, and proceeds to OPERATION 404, where, over a time period, input data 104 from one or more service providers 102 are received. For example, the input data 104 can include various data elements 206 associated with consumer demographic data 304 and ongoing transactions data that provide information about amounts due from consumers 112 and amounts settled by the consumers.

At OPERATION 406, training datasets are built using known or available input data elements 206, and at OPERATION 408, the training datasets are used, in conjunction with known outputs (e.g., historical data), to develop and train a plurality of predictive models 202. In some examples, datasets are sanitized or depersonalized (e.g., certain consumer-identifying data elements are removed from the datasets). In training the plurality of predictive models 202, the models are developed against the training dataset of known inputs (e.g., pieces of demographic data and historical transaction data) to optimize the predictive models to correctly predict the output (e.g., settlement likelihood) for a given input. According to an example, the outputs (e.g., settlement outcomes) are provided to the predictive models 202 and the predictive models 202 are directed to develop a general rule or algorithm that maps the input (e.g., various pieces of demographic data, various pieces of transactional data) to the output. Further, in training the predictive models 202, certain input data elements are systematically omitted to help train the predictive models 202 to predict the output without the elements from the input(s).

The method 400 continues to OPERATION 410, where model diagnostics are performed for determining accuracies of the predictive models 202. For example, the predictive models 202 are evaluated against testing datasets that were not used to train the models and that include known outputs (e.g., settlement outcomes) for their inputs (e.g., pieces of demographic data and historical transaction data). Accuracy scores 208 for each of the predictive models 202 may be determined by the diagnostics engine 116. The predictive models 202 and diagnostics data 204 are then stored at OPERATION 412 in a predictive model and diagnostics storage 118. The method 400 ends at OPERATION 414.

FIG. 4B is a flow chart showing general stages involved in an example method 420 for selecting a best predictive model 202 based on known or available data elements 206 and calculating a propensity score for a consumer 112. The method 420 starts at START OPERATION 422, and proceeds to OPERATION 424, where input data 104 are received for a consumer 112. For example, the input data 104 is provided by a service provider 102 and includes various data elements 206 associated with consumer demographic data 304 and/or ongoing transactions data that provide information about amounts due from a consumer 112 and amounts settled by the consumer.

The method 420 proceeds to DECISION OPERATION 426, where a determination is made as to whether historical transaction report data are available for the consumer 112. For example, the determination may be made based on whether the consumer 112 has an established transactional history or whether the service provider 102 provides enough information to obtain historical transaction report data for the consumer from a CRA 124. When a negative determination is made (e.g., that historical transaction report data are not available for the consumer 112), the method 420 proceeds to DECISION OPERATION 428, where a determination is made as to whether there are historical transaction data for the consumer 112 stored in the historical transactions database 122.

When a negative determination is made (e.g., there is little or no historical transaction data available for providing an indication of the consumer's propensities), the method 420 proceeds to OPERATION 430, where a predictive model 202 is identified as a best model for determining propensities for a consumer 112 based on the highest accuracy score 208 according to known data elements 206.

The method 420 proceeds to DECISION OPERATION 432, where a determination is made as to whether the given predictive model 202 or another predictive model 202 is able to determine propensity with higher accuracy if additional data elements 206 missing from the received input data 104 are known. When a positive determination is made, the method 420 proceeds to OPERATION 434, where the prediction engine 120 communicates with one or more data sources 126 for requesting and receiving additional data elements if they are known. The prediction engine 120 may then populate fields of the selected predictive model 202 with the retrieved data elements.

When a positive determination is made at DECISION OPERATION 426 or DECISION OPERATION 428, when a negative determination is made at DECISION OPERATION 432, or after OPERATION 434, the method 420 proceeds to OPERATION 436, where the prediction engine 120 calculates a propensity score for the consumer 112 indicative of a likelihood of the consumer to settle with the service provider 102. For example, when a determination is made that historical transaction report data are available for the consumer 112 at DECISION OPERATION 426, the prediction engine 120 calculates a propensity score based on the historical transaction report data. According to another example, when a determination is made that historical transaction data for the consumer 112 are available at DECISION OPERATION 428, the prediction engine 120 calculates a propensity score based on the consumer's past settlements for services rendered by the service provider 102 or other service providers. According to another example, when a predictive model 202 is selected at OPERATION 430, the prediction engine 120 calculates a propensity score based on an output of the predictive model 202. In some examples, a suggestion regarding steps to take with the consumer 112 to help the service provider 102 to recover from the consumer 112 are determined.

The method 420 proceeds to OPTIONAL OPERATION 438, where screening options are run for comparing known information about the consumer 112 (e.g., consumer's household size, age) against certain thresholds to determine whether the consumer is eligible for voluntary assistance programs or other programs offered by the government, private charities, or the service provider 102.

At OPERATION 440, the results of the prediction engine 120 and optionally the screener 130 are communicated to the service provider 102. For example, the evaluation system 110 may post back results 106 in a user interface 128 via a web browser or a dedicated application running on a terminal or server operated by the service provider 102. The method 420 ends at OPERATION 498.

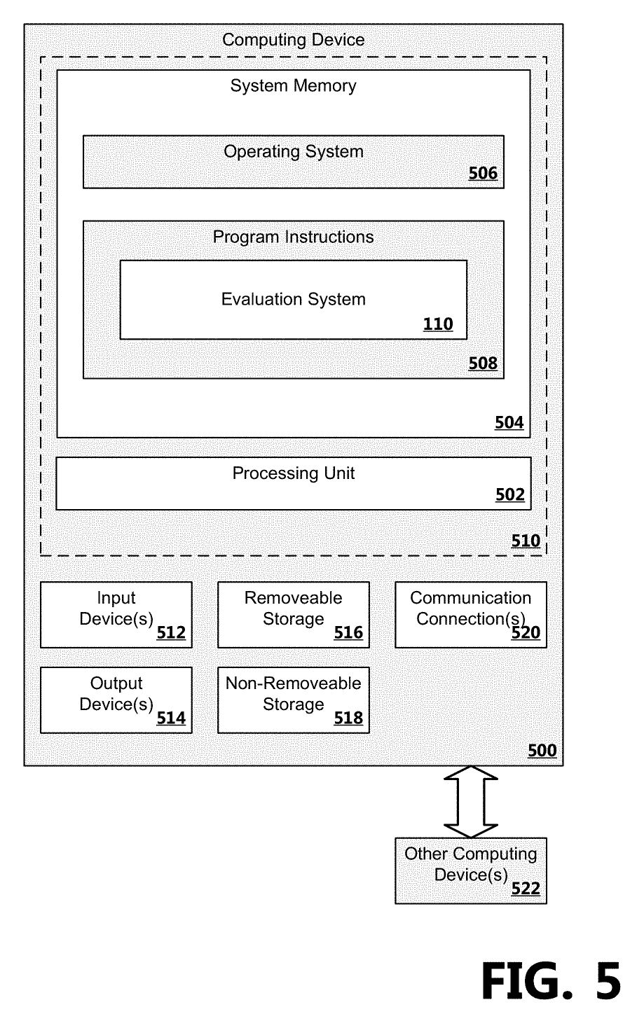

FIG. 5 is a block diagram illustrating physical components of an example computing device with which aspects may be practiced. The computing device 500 may include at least one processing unit 502 and a system memory 504. The system memory 504 may comprise, but is not limited to, volatile (e.g. random access memory (RAM)), non-volatile (e.g. read-only memory (ROM)), flash memory, or any combination thereof. System memory 504 may include operating system 506, one or more program instructions 508, and may include sufficient computer-executable instructions for an evaluation system 110, which when executed, perform functionalities as described herein. Operating system 506, for example, may be suitable for controlling the operation of computing device 500. Furthermore, aspects may be practiced in conjunction with a graphics library, other operating systems, or any other application program and is not limited to any particular application or system. This basic configuration is illustrated by those components within a dashed line 510. Computing device 500 may also include one or more input device(s) 512 (keyboard, mouse, pen, touch input device, etc.) and one or more output device(s) 514 (e.g., display, speakers, a printer, etc.).

The computing device 500 may also include additional data storage devices (removable or non-removable) such as, for example, magnetic disks, optical disks, or tape. Such additional storage is illustrated by a removable storage 516 and a non-removable storage 518. Computing device 500 may also contain a communication connection 520 that may allow computing device 500 to communicate with other computing devices 522, such as over a network in a distributed computing environment, for example, an intranet or the Internet. Communication connection 520 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media do not include computer-readable transmission media.

Aspects of the present invention may be used in various distributed computing environments where tasks are performed by remote processing devices that are linked through a communications network. Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 500 or any other computing devices 522, in combination with computing device 500, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A method for providing a predictive model for enabling more-accurate evaluation of a consumer, the method comprising:
receiving input data from one or more service providers;
building training datasets based on the received input data;
developing and training a plurality of predictive models based on the training datasets;
performing predictive model diagnostics for determining accuracy of the predictive models; and
storing the predictive models and diagnostic data in a storage repository.

2. The method of claim 1, wherein receiving the input data comprises receiving ongoing transactions data and demographic data associated with a consumer.

3. The method of claim 1, wherein developing and training the plurality of predictive models comprises training the predictive models via one or more machine learning techniques.

4. The method of claim 3, wherein training the predictive models via one or more machine learning techniques comprises training the predictive models using supervised learning.

5. The method of claim 4, wherein training the predictive models using supervised learning comprises providing known transaction history data as outputs to develop a rule that maps pieces of demographic data and pieces of ongoing transaction data to the output.

6. The method of claim 5, wherein developing and training the plurality of predictive models comprises systematically omitting data elements in the training dataset to train the predictive models to predict the output without the data elements.

7. The method of claim 1, wherein performing predictive model diagnostics for determining accuracy of the predictive models comprises evaluating the predictive models against testing criteria including known transaction history outputs for demographic data or historical transaction data inputs that the predictive models were not trained on.

8. A method for providing a predictive model for enabling more-accurate evaluation of a consumer, the method comprising:
receiving input data associated with a consumer from a service provider, the input data comprising one or more data elements associated with ongoing transaction data;
analyzing a plurality of predictive models for selecting a predictive model that is responsive to the received input data and satisfies an accuracy threshold;
determining whether the selected predictive model includes one or more fields associated with one or more data elements that are not included in the received input data;
responsive to a positive determination, retrieving one or more of the one or more not-included data elements from one or more data sources; and
generating a propensity score for the consumer, using the selected predictive model, based on the one or more data elements.

9. The method of claim 8, wherein selecting the predictive model that is responsive to the received input data and satisfies the accuracy threshold comprises selecting a predictive model that has a highest accuracy score based on using one or more of the received input data elements as inputs.

10. The method of claim 8, wherein receiving input data associated with the consumer comprises receiving one or more demographic data elements.

11. The method for claim 8, further comprising providing results to the service provider, the results including the propensity score or suggestions based on the propensity score.

12. The method of claim 8, further comprising running one or more screening options for comparing known data elements against certain thresholds to determine whether the consumer is eligible for a voluntary assistance program.

13. A system for providing a predictive model for enabling more-accurate evaluation of a consumer, comprising:
a processor; and
a computer readable memory storage device, including instructions, which when executed by the processor are operative to enable the system to:
receive input data from one or more service providers;
build training datasets based on the received input data;
develop and train a plurality of predictive models based on the training datasets;
perform predictive model diagnostics for determining accuracy of the predictive models;
store the predictive models and diagnostic data in a storage repository;
receive input data associated with a consumer from a service provider, the input data comprising one or more data elements associated with ongoing transaction data;
analyze a plurality of predictive models for selecting a predictive model that is responsive to the received input data and satisfies an accuracy threshold;
determine whether the selected predictive model includes one or more fields associated with one or more data elements that are not included in the received input data;
responsive to a positive determination, retrieve one or more of the one or more not-included data elements from one or more data sources; and
generate a propensity score for the consumer, using the selected predictive model, based on the one or more data elements.

14. The system of claim 13, wherein in developing and training the plurality of predictive models, the system is operative to train the predictive models via one or more machine learning techniques.

15. The system of claim 14, wherein in training the predictive models via one or more machine learning techniques, the system is operative to provide known transaction history data as outputs to develop a rule that maps elements of demographic data and elements of ongoing transaction data to the output.

16. The system of claim 15, wherein in developing and training the plurality of predictive models, the system is operative to systematically omit data elements in the training dataset to train the predictive models to predict the output without the data elements.

17. The system of claim 13, wherein in performing predictive model diagnostics for determining accuracy of the predictive models, the system is operative to evaluate the predictive models against testing criteria including known transaction history outputs for demographic data or historical transaction data inputs that the predictive models were not trained on.

18. The system of claim 13, wherein in selecting the predictive model that is responsive to the received input data and satisfies the accuracy threshold, they system is operative to select a predictive model that has a highest accuracy score based on using one or more of the received input data elements as inputs.

19. The system of claim 13, wherein the system is further operative to provide results to the service provider, the results including the propensity score or suggestions based on the propensity score.

20. The system of claim 13, wherein the system is further operative to run one or more screening options for comparing known data elements against certain thresholds to determine whether the consumer is eligible for a voluntary assistance program.
